(19) United States
(12) Patent Application Publication
(10) Pub. No.: US 2026/0121140 A1
(43) Pub. Date: Apr. 30, 2026

(54) SYSTEMS AND METHODS FOR DETECTION OF BATTERY DEFORMATION

(71) Applicant: Tyco Fire Products LP, Cranston, RI (US)

(72) Inventors: Sean S. Troutt, Stephenson, MI (US); Blake Bomann, Greenville, WI (US); Ben Markovitz, Howard, WI (US); David Strobel, Marinette, WI (US)

(73) Assignee: Tyco Fire Products LP, Cranston, RI (US)

(21) Appl. No.: 19/120,927

(22) PCT Filed: Jan. 11, 2024
(86) PCT No.: PCT/IB2024/050311

§ 371 Date: Apr. 14, 2025

Related U.S. Application Data
(60) Provisional application No. 63/480,637, filed on Jan. 19, 2023.

(51) Int. Cl. H01M 10/48; A62C 3/16; B60L 3/00; G01B 7/16; G01B 11/16; H01M 50/24; H01M 50/249

(52) U.S. Cl. CPC H01M 10/482; A62C 3/16; B60L 3/0046; G01B 7/18; G01B 11/16; H01M 50/24; H01M 50/249; H01M 2220/20

(57) ABSTRACT

A battery pack comprising a housing defining a volume. The battery pack includes a battery module arranged within the housing, where the battery module comprises a plurality of battery cells configured to provide an electrical output. The battery pack includes a first detector positioned within the battery module proximate to the plurality of battery cells, where the first detector is configured to detect a deformation of one of the plurality of battery cells to identify a potential thermal runaway.

### CROSS-REFERENCE TO RELATED PATENT APPLICATION

This application claims the benefit of and priority to U.S. Provisional Application No. 63/480,637, filed on Jan. 19, 2023, the entire disclosure of which is hereby incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

At least one implementation relates to a battery pack. The battery pack includes a housing defining a volume, and a battery module arranged within the housing, wherein the battery module comprises a plurality of battery cells configured to provide an electrical output. The battery pack includes a detector positioned within the battery module proximate to the plurality of battery cells, where the detector is configured to detect a deformation of one of the plurality of battery cells to identify a potential thermal runaway.

In some implementations the first detector is configured to detect a deformation of one of the plurality of battery cells based on a comparison of a measured characteristic of the battery cell to a predefined characteristic threshold.

In some implementations the deformation of the one of the plurality of battery cells is a detected change in a characteristic of the battery cell.

In some implementations the first detector is coupled to one of the plurality of battery cells, where the first detector includes a strain gauge configured to detect the deformation of a housing of the one of the plurality of battery cells.

In some implementations an exterior surface of housings of the plurality of battery cells include a pattern.

In some implementations the first detector is coupled to an interior wall of the battery module, where the first detector includes an optical sensor configured to detect the deformation of the one of the plurality of battery cells via an alteration of the pattern on the exterior surface of the housing.

In some implementations the first detector is coupled to an interior wall of the battery module, where the first detector includes an acoustic sensor configured to transmit an electromagnetic signal within the battery module, and receive, via reflection off a housing of the one of the plurality of battery cells, a reflected electromagnetic signal at a first frequency.

In some implementations the acoustic sensor is configured to transmit the electromagnetic signal within the battery module, and receive, via reflection off the housing of the one of the plurality of battery cells, the reflected electromagnetic signal at a second frequency in response to the deformation of the one of the plurality of battery cells.

In some implementations the first detector includes an acoustic sensor configured to detect an audible sound or noise indicative of the potential thermal runaway.

In some implementations the battery pack further comprises a second detector positioned within the battery pack, where the second detector is configured to detect a deformation of the battery module to identify a failure event.

In some implementations the second detector is coupled to the battery module, where the second detector includes a heat flux sensor configured to detect an increase in energy transfer through a surface of the battery module indicative of the potential failure event.

Another implementation relates to a vehicle. The vehicle includes a chassis and a plurality of tractive elements coupled with the chassis. The vehicle includes a prime mover coupled with the plurality of tractive elements, the prime mover configured to drive the plurality of tractive elements to propel the vehicle, and a battery pack coupled with the prime mover. The battery pack includes a housing defining a volume, and a battery module arranged within the housing, where the battery module comprises a plurality of battery cells configured to provide an electrical output. The battery pack including a first detector positioned within the battery module proximate to the plurality of battery cells, where the first detector is configured to detect a deformation of one of the plurality of battery cells to identify a potential thermal runaway.

In some implementations the first detector is configured to detect a deformation of one of the plurality of battery cells based on a comparison of a measured characteristic of the battery cell to a predefined characteristic threshold.

In some implementations the deformation of the one of the plurality of battery cells is a detected change in a characteristic of the battery cell.

In some implementations the first detector is coupled to one of the plurality of battery cells, and wherein the first detector includes a strain gauge configured to detect the deformation of a housing of the one of the plurality of battery cells.

In some implementations an exterior surface of housings of the plurality of battery cells include a pattern, where the first detector is coupled to an interior wall of the battery module, and the first detector includes an optical sensor configured to detect the deformation of the one of the plurality of battery cells via an alteration of a pattern on the exterior surface of the housing.

Another implementation relates to a battery system. The battery system includes a housing defining a volume, and a battery module arranged within the housing, where the battery module comprises a plurality of battery cells configured to provide an electrical output. The battery system includes a first detector positioned within the battery module proximate to the plurality of battery cells, where the first detector is configured to detect a deformation of one of the plurality of battery cells to identify a potential thermal runaway event, and a suppression system having a suppressant, where the suppression system is configured to provide the suppressant to the battery module to mitigate the identified potential thermal runaway event.

In some implementations the first detector is configured to detect a deformation of one of the plurality of battery cells based on a comparison of a measured characteristic of the battery cell to a predefined characteristic threshold.

In some implementations the deformation of the one of the plurality of battery cells is a detected change in a characteristic of the battery cell.

In some implementations the first detector is coupled to one of the plurality of battery cells, where the first detector includes a strain gauge configured to detect the deformation of a housing of the one of the plurality of battery cells.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an example implementation.

FIG. 2 is a block diagram of a control system for the battery system of FIG. 1, according to an example implementation.

FIG. 3 is a left side view of a vehicle utilizing the battery system of FIG. 1, according to an example implementation.

FIG. 4 is a perspective view of a containerized energy storage system including the battery system of FIG. 1, according to an example implementation.

FIG. 5 is a schematic diagram of the battery system of FIG. 1, according to an example implementation.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a battery pack having a detector configured to detect deformation of one or more components of the battery pack, in order to identify, prevent, eliminate, and/or mitigate a failure or thermal runaway event is shown, according to various implementations. In some implementations, the battery pack includes a housing defining a volume, and a battery module arranged within the housing, where the battery module comprises a plurality of battery cells configured to provide an electrical output. The battery pack also includes a detector positioned within the battery module proximate to the plurality of battery cells, where the detector is configured to detect a deformation of one of the plurality of battery cells to identify a potential thermal runaway. In this regard, the battery pack described herein may include a detector positioned within the battery pack (e.g., a battery module, a subpack, etc.), proximate to the plurality of battery cells, configured to detect and address deformation of a battery cell.

In various implementations, the battery pack described herein is configured to include detectors distributed throughout the battery pack. Energy is produced and stored inside the battery cells, battery modules, and/or subpacks of battery packs; however, in some circumstances components of the battery pack are stressed near or beyond their design limits (e.g., via pressure, gases, temperature increases, etc.), for example via internal energy production or internal defects. These stressors (e.g., pressure, gas production, temperature increases, etc.) can lead to deformation (e.g., alteration, distortion, movement, etc. of components or component properties) of one or more components of the battery pack. As such, one or more detectors may be distributed throughout the battery pack so as to detect or identify deformation of a component of the battery pack, for example prior to a potential failure or thermal runaway event. As discussed herein, a “potential” failure or thermal runaway event may describe a characteristic or state of a component of a battery pack that crosses a first predetermined threshold, for example indicating that a failure or thermal runaway event is impending, approaching, and/or likely. A failure or thermal runaway event may describe a characteristic or state of a component of a battery pack that crosses a second predetermined threshold (e.g., different than the first, etc.), for example indicating that a failure or thermal runaway event is currently occurring and/or has occurred. For example, a battery cell may bulge or expand a first amount, which crosses a first predetermined threshold (e.g., exceeding a first threshold, outside a first range, etc.) indicating that a “potential” failure or thermal runaway event may occur. If the event is not addressed, the battery cell may continue to bulge or expand to a second amount, which crosses a second predetermined threshold (e.g., exceeding a second threshold, outside a second range, etc.) indicating that a failure or thermal runaway event is occurring or has occurred.

In various implementations, the detectors are coupled to, and/or arranged adjacent to, one or more components of the battery pack, for example the battery cells, the battery module, the subpack, the battery pack itself, etc. The detector may include a suitable sensor (e.g., a strain gauge, an optical sensor, an acoustic sensor, a radiative sensor, etc.) configured to detect a deformation, and/or additional elements (e.g., communications interface, processor, memory, etc.) suitable for identifying and/or addressing a failure or runaway event. In some implementations, the detector is configured to communicate with a fire suppression system, so as to initiate delivery (e.g., local, general, etc.) of a suppressant to prevent or mitigate a failure or runaway. In some implementations, the detector is configured to communicate with other components (e.g., a controller, a component of a vehicle, etc.) for example to provide an alert to initiate an automated action to prevent or mitigate a failure or runway event. In this regard, the configuration of the detectors may detect, prevent, and/or mitigate potential losses associate with a hazard event.

### System Overview

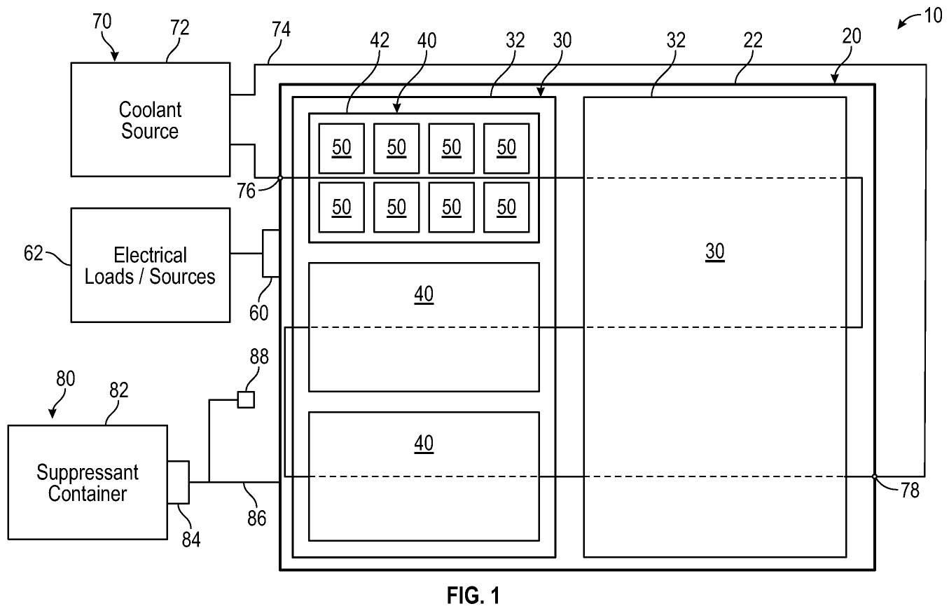

Referring to FIG. 1, a power system or battery system, shown as system 10, includes an energy storage device, energy storage assembly, battery assembly, power source, or electrical energy source, shown as battery pack 20, according to an example implementation. The battery pack 20 is configured to store energy (e.g., chemically) and later discharge the stored energy as electrical energy to power one or more electrical loads (e.g., electric motors, resistive elements, lights, speakers, etc.). In some implementations, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In some implementations, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In some implementations, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In some implementations, each battery module 40 includes more or fewer battery cells 50. Each battery cell 50 is configured to store a portion of the energy stored by the corresponding battery module 40.

In some implementations, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In some implementations, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some implementations, the subpacks 30 are omitted, and the battery modules 40 are positioned directly within the battery pack 20.

In some implementations, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some implementations, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82.

The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). The distribution network 86 can transfer the suppressant to the exterior of the battery pack 20. By way of example, the distribution network 86 may provide the suppressant to an outlet, shown as nozzle 88, that is positioned to direct suppressant to the exterior of the pack housing 22.

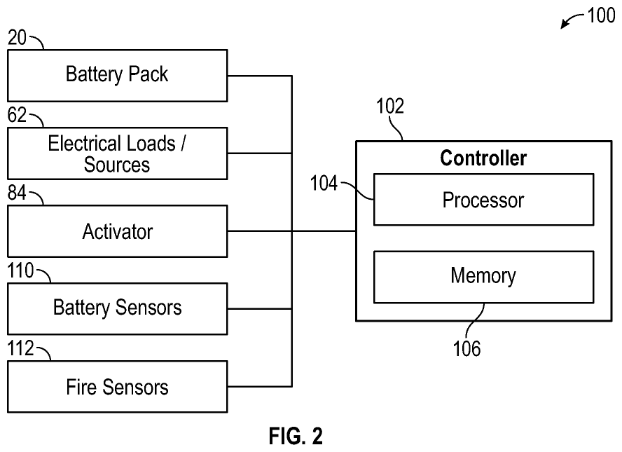

Referring to FIG. 2, a control system 100 of the system 10 is shown according to an example implementation. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some implementations, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the suppression system 80.

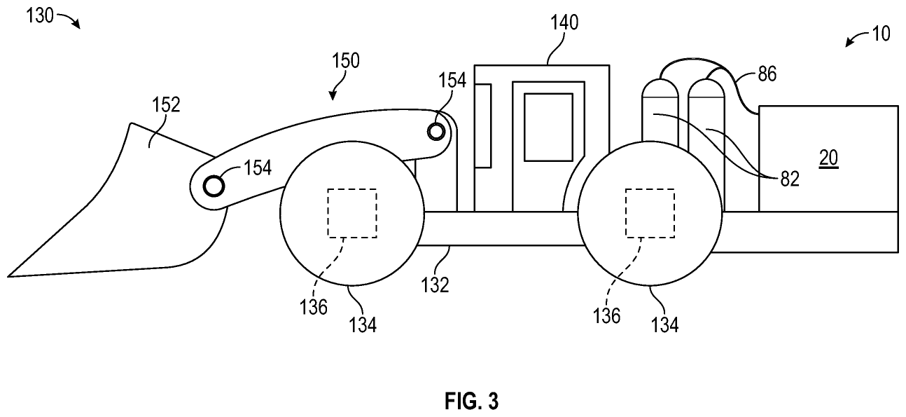

Referring to FIG. 3, a vehicle 130 is equipped with the battery system 10, according to an example implementation. As shown, the vehicle 130 is configured as a mining vehicle. Specifically, the vehicle 130 is configured as a front end loader. In some implementations, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some implementations, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

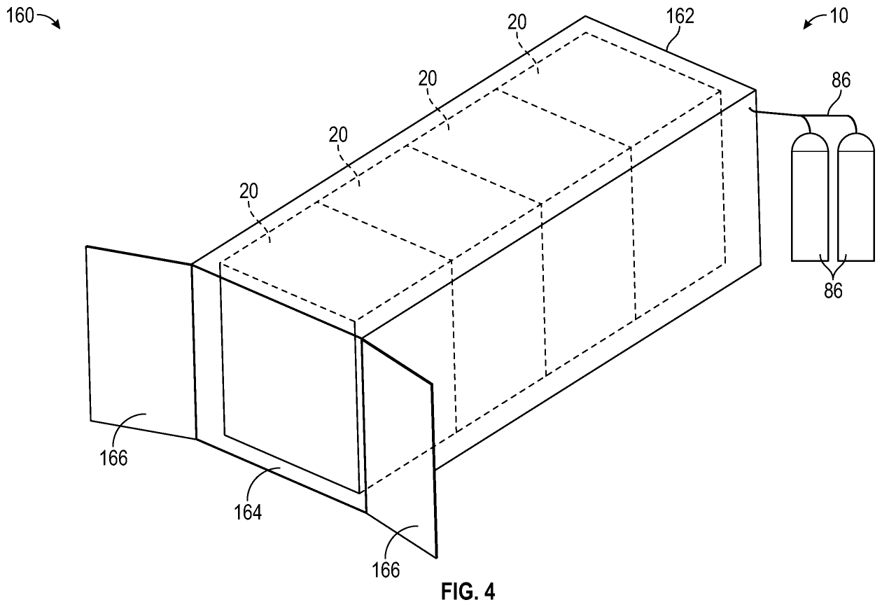

Referring to FIG. 4, a containerized energy storage system, shown as container system 160, is equipped with the battery system 10, according to an example implementation. In some implementations, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### Systems and Methods for Detection of Battery Deformation

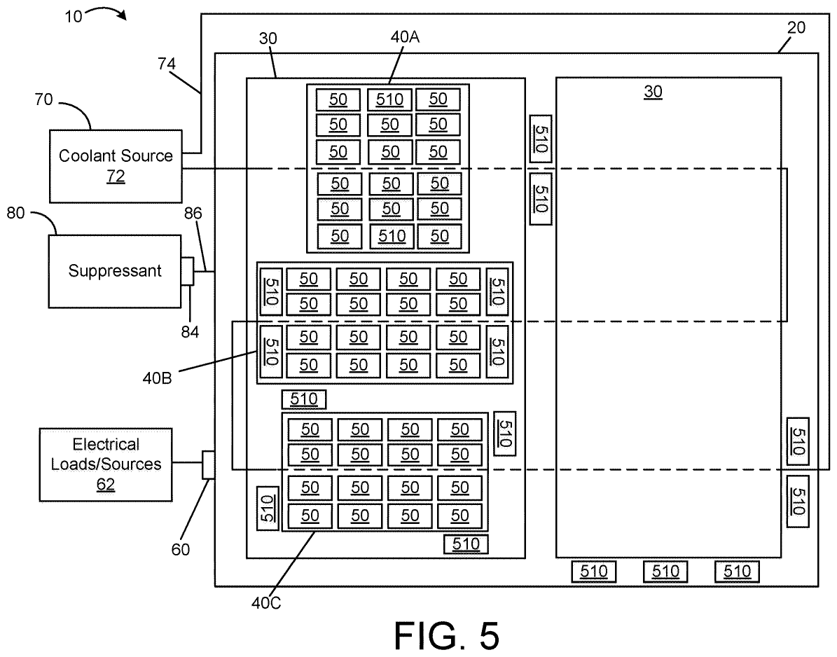

Referring now to FIG. 5, a power system or battery system is shown, according to an example implementation. In various implementations, the power system or battery system is the system 10 of FIG. 1. The system is shown to include the battery pack 20 having the subpacks 30, battery modules 40, and battery cells 50. The system 10 may also include the cooling system 70, the suppression system 80, and/or the electrical port 60 to power the electrical loads/sources 62 (e.g., via components of the battery pack 20). The system 10 may also be used in combination with the control system 100 of FIG. 2, the vehicle 130 of FIG. 3, and/or the container system 160 of FIG. 4.

According to some implementations, the battery pack 20 includes one or more detectors or sensors. The detectors may be positioned within the battery pack 20, and may be configured to detect deformation (e.g., alteration, distortion, movement, etc.) of one or more components of the battery pack 20 in order to prevent, eliminate, and/or mitigate a failure or thermal runaway event. Given that the source of a failure or thermal runaway event may be located in difficult to analyze or access locations (e.g., within the battery pack 20, remote from an external detection system, etc.), detection of a failure or runaway event may be difficult. Accordingly, and as described herein, detectors may be positioned within the battery pack 20 so as to more efficiently and/or effectively detect deformation of one or more components of the battery pack 20 (e.g., compared to traditional systems or battery packs). Further, the detectors may be specifically arranged and/or positioned within the battery pack 20 (e.g., adjacent components that are more likely to experience a deformation event, etc.), for example to more efficiently and/or effectively detect deformation of one or more components within the battery pack 20. Finally, the detectors may be arranged and/or positioned within the battery pack 20 and/or components thereof (e.g., within battery subpacks or battery modules, adjacent battery subpacks or battery module housings, etc.), for example to reduce empty space within the battery pack 20 and/or the overall size of the battery pack 20.

As shown in FIG. 5, the battery pack 20 includes a series of subpacks 30 and a series of battery modules 40. The battery pack 20 is shown to include two subpacks 30; however, in some implementations the battery pack 20 includes any suitable number of subpacks 30 (e.g., 1, 4, 10, 15, 20, etc.). Further, each subpack 30 is shown to include three battery modules 40, shown as battery module 40A, battery module 40B, and battery module 40C. However, in some implementations the subpack 30 includes any suitable number of battery modules 40 (e.g., 5, 8, 10, 20, 25, 50, etc.). In various implementations, the battery modules 40 (e.g., battery modules 40A-40C) include a series of battery cells 50. In some implementations, the battery modules 40 (e.g., battery modules 40A-40C) include one or more detectors 510. As will be discussed below, the detectors 510 may include various components (e.g., sensors, gauges, processors, memory, communications interfaces, etc.), and may be configured to detect deformation of one or more components of the battery pack 20 (e.g., the battery cells 50, the battery module 40, the subpack 30, etc.) in order to prevent, eliminate, and/or mitigate a failure or thermal runaway event.

As shown in FIG. 5, the battery modules 40 (battery modules 40A-40C) include a plurality of battery cells 50. In various implementations, the battery modules 40 are designed (e.g., size, shape, etc.) to reduce the empty space within the battery module 40 and/or the overall size of the battery pack 20, for example by complimenting the configurations of the components housed therein (e.g., battery cells 50, detectors 510, etc.). According to some implementations, the battery modules 40 include a number of battery cells 50 arranged in a matrix, so as to reduce the empty space within the battery module 40. For example, the battery cells 50 (e.g., 10, 50, 100, 250, etc.) may be arranged in a matrix having rows (e.g., 5, 10, 25, 50, etc.) that are adjacent to one another. In some implementations, the battery cells 50 are arranged in a matrix having another suitable pattern and/or configuration (e.g., concentric rings, circles, squares, stacked, layered, etc.). In various implementations, the battery cells 50 are lithium-ion (i.e., Li-ion) battery cells, which may be cylindrical cells, prismatic cells, pouch cells, or another form factor of battery cells. However, in some implementations, the battery cells 50 are other suitable battery cells.

As shown in FIG. 5, the battery modules 40 may also include one or more detectors 510. In various implementations, the detectors 510 include a suitable sensor (e.g., a strain gauge, an optical sensor, an acoustic sensor, a radiative sensor, etc.) configured to detect a deformation (e.g., alteration, distortion, movement, of components and/or component properties, etc.) of one or more components of the battery pack 20, so as to identify and/or address a failure or thermal runaway event. For example, a detector 510 may detect a failure or runaway event (e.g., temperature increase, fire, gas release, expansion, contraction, etc.) of one or more of the battery cells 50, battery modules 40, subpacks 30, etc. The detector 510 may further communicate with a fire suppression system (e.g., the suppression system 80, a suppressant canister, etc.) to initiate a response to prevent and/or mitigate the failure or runaway event. In some implementations, the detector 510 is also configured communicate with a controller (e.g., the controller 102), so as to provide an alert indicative of the failure or runaway event. In some implementations, the detector 510 is further configured to communicate with one or more components of a vehicle (e.g., the vehicle 130), so as to provide an alert, or initiate an automated action, to identify, prevent, or mitigate a failure or thermal runaway event. As will be discussed below, the detectors 510 may be configured to identify select characteristics (e.g., size, shape, thermal, electrical, optical, acoustic, etc.) of one or more components of the battery pack 20, so as to detect and/or address potential failure or thermal runaway events.

As discussed above, in some implementations the detectors 510 are configured to detect a deformation of one or more components of the battery pack 20. As discussed herein, deformation may include an alteration, a distortion, a deviation, a change, a variation, etc. in one or more characteristics or states of a component of the battery pack 20 (e.g., one or more of the battery cells 50, battery modules 40, subpacks 30, etc.). For example, the detector 510 may be configured to detect an expansion, bulge, pillowing, swelling, ballooning, protrusion, and/or another alteration of a component of the battery pack 20. The detector 510 may be configured to detect a movement, motion, vibration, quiver, and/or other suitable alteration of position of a component of the battery pack 20. In some implementations, the detector 510 is configured to detect an explosion, discharge, ignition, outburst, etc. at a component of the battery pack 20, for example the detector 510 may be configured to detect release of a cap of a battery cell 50 (e.g., in response to an explosion or eruption at the battery cell 50). In some implementations, the detector 50 is configured to detect a deflection or deviation of a component of the battery pack 50 (e.g., within a grid, an optical grid, etc.). In some implementations, the detector 510 is configured to detect an increase, variation, change, etc. of a temperature, pressure, offgas, and/or another suitable battery component characteristics at a component of the battery pack 20.

In some implementations, the detectors 510 are configured to detect a deformation of one or more components of the battery pack 20 by analyzing the detected component characteristic or state against predetermined component characteristic or state information. For example, the detector 510 may be configured to detect a deformation based on a comparison of the detected characteristic against a predetermined threshold (e.g., a manufacturer defined threshold, a user defined threshold, etc.). In some implementations, the detector 510 is configured to detect a deformation based on the detected characteristic exceeding a first predetermined threshold and/or falling below second a predetermined threshold. In some implementations, the detector 510 is configured to detect a deformation based on the detected characteristic falling outside a predetermined range of characteristic measurements.

In some implementations, the detectors 510 include strain gauges coupled to one or more components of the battery pack 20 (e.g., battery cell 50, battery module 40, subpack 30, battery pack 20, etc.). In various implementations, the detectors 510 (e.g., strain gauges) are configured to detect a deformation of a component of the battery pack 20 (e.g., expansion, contraction, an alteration in size, shape, etc.), for example in response to a failure or runaway event. For example, the detector 510 may be coupled to the housing of a battery cell 50. In the case of a failure or runaway event, the housing of the battery cell 50 may deform (e.g., expand, contract, alter in shape, size, etc.). The strain gauge may detect the deformation (e.g., of the housing), and/or the detector 510 may communicate with a fire suppression system (e.g., the suppression system 80, a suppressant canister, etc.) to initiate a response to eliminate or mitigate the failure or runaway event.

In some implementations, the detectors 510 include optical sensors configured to detect a deformation of a component of the battery pack 20 (e.g., battery cell 50, battery module 40, subpack 30, battery pack 20, etc.). For example, the housing of a battery cell 50 may include a pattern on an exterior surface of the housing (e.g., cross-hatching, herringbone, checkered, etc.). In the case of a failure or thermal runaway event, the housing of the battery cell 50 may deform (e.g., expand, contract, alter in shape, size, orientation, etc.), for example causing the external pattern to deform or become altered. The detector 510 (e.g., the optical sensor) may detect the deformation of the housing of the battery cell 50 (e.g., via deformation of the exterior pattern, etc.), and/or communicate with a fire suppression system (e.g., the suppression system 80, a suppressant canister, etc.) to initiate a response to eliminate or mitigate the failure or runaway event.

In some implementations, the detectors 510 include acoustic sensors configured to detect a deformation of a component of the battery pack 20. For example, a detector 510 may be positioned within the battery pack 20 (e.g., the battery module 40, etc.), and may be configured to transmit an electromagnetic signal to components of the battery pack 20 (e.g., a battery cell 50, etc.). In various implementations, the battery cell 50 includes a housing formed of a rigid material (e.g., metal, etc.). In response to the detector 510 transmitting the signal, the signal (e.g., electromagnetic wave, etc.) may be reflected off the battery cell 50 housing, and transmitted back to the detector 510 at a first frequency (e.g., a consistent, natural, etc. frequency). In the case of a failure or thermal runaway event, the battery cell 50 housing may deform (e.g., alter material or mechanical properties of the housing, etc.) causing the signal to be reflected and/or transmitted back to the detector 510 at a second frequency (e.g., an altered frequency, a different frequency, etc.). Based on the second frequency, the detector 510 (e.g., the acoustic sensor) may detect the deformation of the battery cell 50, and/or communicate with a fire suppression system to initiate a response to eliminate or mitigate the failure or runaway event. In some implementations, the detectors 510 include acoustic sensors configured to detect a sound or audible noise, which may be indicative of a failure or thermal runaway event (e.g., a pressure increase or seep in a battery cell 50, a gas or electrolyte leak from a battery cell 50, etc.).

In some implementations, the detectors 510 include heat flux sensors coupled to one or more components of the battery pack 20, and are configured to detect a deformation of a component of the battery pack 20. For example, the detector 510 (e.g., heat flux sensor) may be coupled to a battery cell 50, and may be configured to measure an energy (e.g., flux) transfer through one or more surfaces of the battery cell 50. In the case of a failure or thermal runaway event, the battery cell 50 may generate an increased energy output, for example causing the battery cell 50 to increase in temperature. The detector 510 (e.g., heat flux sensor) may detect an increase in temperature of the battery cell 50 (e.g., an increased energy transfer through one or more surfaces of the battery cell 50), and/or communicate with a fire suppression system (e.g., the suppression system 80, a suppressant canister, etc.) to initiate a response to eliminate or mitigate the failure or runaway event. It should be understood that while the detectors 510 are described herein as being of certain configurations (e.g., including a strain gauge, an optical sensor, an acoustic sensor, a radiative sensor, etc.) and/or configured to detect a deformation of a battery cell 50, it is contemplated that the detectors 510 may be of any suitable configuration (e.g., include a pressure sensor, infrared sensor, etc.) and/or detect a deformation of any suitable component of the battery pack 20 (e.g., battery module 40, subpack 30, battery pack 20, etc.) so as to detect, eliminate, and/or mitigate a failure or thermal runaway event of the battery pack 20.

As shown in FIG. 5, the detectors 510 may be variously configured within the battery pack 20. For example, the detectors 510 may be coupled to, and/or dispersed among, a matrix of battery cells 50 within the battery module 40. In some implementations, the detectors 510 are coupled to, and/or dispersed among, other components of the battery pack 20 (e.g., battery modules 40, subpacks 30, battery pack 20, etc.). In some implementations, the detectors 510 are of suitable form factor (e.g., shape, size, configuration, etc.) relative to adjacent components of the battery pack 20, so as to be interspersed to reduce the empty space within the battery pack 20. In various implementations, the distribution of the detectors 510 is configured to facilitate timely detection and/or identification of deformation (e.g., alteration, distortion, movement, temperature change, etc.) of one or more components of the battery pack 20 (e.g., battery cells 50, battery modules 40A-40C, subpack 30, etc.), for example in response to a failure or thermal runaway event.

For example, the battery module 40A of FIG. 5 is shown to include two detectors 510 coupled to and/or arranged adjacent to battery cells 50, at a top portion and a bottom portion of the battery module 40A. In this regard, the battery module 40A shows the detectors 510 may be coupled to and/or uniformly dispersed within a matrix of battery cells 50 (e.g., the battery module 40A). In some implementations, the detectors 510 are uniformly dispersed within a matrix of battery cells 50 (e.g., the battery module 40A) in another configuration or pattern (e.g., at each battery cell 50, at a top, bottom, front, back, lateral side, etc. portion of the battery module 40A). In some implementations, the detectors 510 are clustered at a first portion of the battery module 40A (e.g., a central portion, etc.) and/or dispersed at a second portion (e.g., a perimeter portion, etc.). In some implementations, the detectors are arranged in another configuration or pattern within the battery module 40A (e.g., around a perimeter, in concentric squares, rectangles, circles, etc., horizontal snaking rows, vertical snaking columns, etc.). In some implementations, the detectors 510 are grouped at a portion of the battery module 40A (e.g., a first corner, a second corner, opposite corners, a top or bottom wall, a side wall, etc.), and/or absent from another portion of the battery module 40A (e.g., adjacent a cooling channel, etc.). Further, the battery module 40B of FIG. 5 is shown to include detectors 510 positioned within the battery module 40B and/or nested along a matrix of battery cells 50. As discussed above, the detectors 510 may be selectively distributed throughout the battery module 40 so as to reduce the empty space within the battery module 40. As shown in FIG. 5, the detectors 510 may be coupled to and/or arranged along an end portion of the battery module 40B (e.g., an end wall), between the battery module 40B and a matrix of battery cells 50. In some implementations, the detectors 510 are coupled to and/or arranged along another portion of the battery module 40B (e.g., a first end, a second end, a top wall, a bottom wall, a front wall, a back wall, a first corner, a second corner, etc.). In some implementations, the detectors are coupled to and/or arranged in another suitable pattern, configuration, or otherwise within the battery module 40B, so as to facilitate timely detection and/or identification of deformation of one or more components of the battery pack 20.

As shown in FIG. 5, in some implementations the detectors 510 are coupled to and/or arranged adjacent to other components of the battery pack 20. For example, the detectors 510 may be positioned within the subpack 30, adjacent to the battery module 40C (and the battery cells 50 contained therein). The battery module 40C is shown to include detectors 510 coupled to, and/or arranged around, an exterior perimeter of the battery module 40C (e.g., at corners); however, in some implementations the detectors 510 are positioned in another suitable pattern, configuration, or otherwise within the subpack 30 (e.g., adjacent to the battery module 40C, between the battery modules 40, etc.). In the various implementations shown in FIG. 5, the detectors 510 may further be positioned within the battery pack 20, adjacent to one or more of the subpacks 30 (e.g., and the battery modules 40 contained therein). The subpacks 30 are shown to include detectors 510 coupled to, and/or arranged around, an exterior perimeter of the subpacks 30; however, in some implementations the detectors 510 are arranged in another suitable pattern, configuration, or otherwise within the battery pack 20. It should be understood that while the detectors 510 are described herein as being coupled to, and/or distributed in, certain configurations within components of the battery pack 20 (e.g., battery modules 40A-40C, subpack 30, etc.), it is contemplated that the detectors 510 may be in any suitable pattern, configuration, or otherwise relative to components of the battery pack 20 so as to facilitate timely detection and/or identification of a failure or thermal runaway event.

In some implementations, the detectors 510 are specifically positioned and/or arranged within the battery pack 20 (e.g., to more efficiently and/or effectively detect deformation of a component of the battery pack 20). In some implementations, the detectors 510 are positioned adjacent to components that are more likely to experience a deformation event. For example, the detectors 510 may be positioned adjacent one or more charging ports and/or electrical connectors (e.g., between battery modules, subpacks, etc.). In some implementations, the detectors 510 are specifically positioned and/or arranged within the battery pack 20 based on the type of the detector 510. For example, when the detectors 510 are strain gauges and/or heat flux sensors, the detectors 510 may be positioned within a battery module (e.g., the battery module 40B) and/or adjacent the battery cells (e.g., the batter cells 50), for example to detect a deformation at the battery module and/or battery cell level. When the detectors 510 are optical sensors and/or acoustic sensors, the detectors 510 may be positioned outside the subpack and/or battery module (e.g., the subpack 30, battery modules 40, etc.), for example to detect a deformation at the subpack and/or battery module level.

According to various implementations, the detectors 510 are also of varying configurations (e.g., include a strain gauge, an optical sensor, an acoustic sensor, a radiative sensor, etc.) and/or include additional, fewer, or different working components (e.g., a communications interface, activator, etc.). For example, the battery module 40A of FIG. 5 is shown to include two detectors 510 coupled to, and/or arranged adjacent to, battery cells 50 at a top and a bottom portion of the battery module 40A. The detectors 510 of battery module 40A may include strain gauges, and may be configured to detect deformation of a battery cell 50 contained within the battery module 40A. The detectors 510 of battery module 40A may further be configured to communicate with a fire suppression system (e.g., the suppression system 80, a suppression canister, etc.), so as to initiate local delivery of a suppressant to the battery cell 50 to eliminate and/or mitigate a failure or runaway event. Further, the battery module 40B of FIG. 5 is shown to include four detectors 510 coupled to, and/or arranged adjacent to, ends of the battery module 40B, between the battery module 40B and a matrix of battery cells 50. The detectors 510 of battery module 40B may include optical sensors and/or acoustic sensors, and may be configured to detect deformation of one or more battery cells 50 within the battery module 40B. The detectors 510 of the battery module 40B may also be configured to communicate with a fire suppression system, so as to initiate general delivery of a suppressant to the battery module 40B to mitigate the failure or runaway event. In addition, the battery module 40C of FIG. 5 is shown to include four detectors coupled to, and/or arranged around, an exterior of the battery module 40C. The detectors 510 of battery module 40C may include heat flux sensors, and may be configured to detect a change in energy output (e.g., a temperature increase) of the battery module 40C and/or components therein. The detectors 510 of the battery module 40C may be configured to communicate with a fire suppression system, as discussed above, and/or a controller (e.g., the controller 102) or components of a vehicle (e.g., the vehicle 130) to provide an alert indicative of a failure or runaway event and/or initiate an automated action (e.g., shut down, etc.) to mitigate the failure or runaway event. In some implementations, the detectors 510 are otherwise distributed and/or configured, such that the detectors 510 are configured to facilitate timely detection and identification of deformation (e.g., modification, alteration, etc.) of one or more components of the battery pack 20.

As an illustrative example, the components of FIGS. 1-5 may be used to detect, address, and/or mitigate a failure or thermal runaway event of the battery pack 20. According to various implementations, the battery pack 20 includes the battery modules 40 (e.g., the battery module 40A, battery module 40B, battery module 40C), battery cells 50, and/or the detectors 510 shown in FIG. 5. The battery pack 20 may also be in communication with the cooling system 70, which may be configured to facilitate maintaining a consistent, low operating temperature of the battery pack 20. However, in some instances the cooling system 70 is unable to maintain a consistent and/or low operating temperature of the battery pack 20.

In some circumstances, components of the battery pack 20 may begin to operate at elevated current levels, temperatures, pressures, and/or other characteristics indicative of a failure or thermal runaway event. For example, a battery cell 50 of the battery module 40A may begin to operate at an elevated current level, resulting in an elevated temperature or pressure in the battery cell 50. A detector 510 coupled to, and/or arranged adjacent with, the battery cell 50 may detect a deformation of the battery cell 50 (e.g., via expansion and/or contraction of the housing, an alteration of an exterior pattern on the housing, etc.). In response to detecting the deformation of the battery cell 50, the detector 510 may communicate with a fire suppression system (e.g., the suppression system 80, a suppressant canister, etc.), so as to initiate local delivery of a suppressant to the battery cell 50. In this regard, the detector 510 may be configured to detect and/or address a deformation of a battery cell 50, so as to prevent, eliminate, and/or mitigate the identified failure or thermal runaway event.

In other circumstances, one or more battery cells 50 (e.g., of the battery module 40B) may begin to operate at an elevated current level, resulting in an elevated temperature and/or the leakage of gas in the battery module 40B. A detector 510 coupled to the battery module 40B, and/or arranged adjacent to a matrix of battery cells 50 within the battery module 40B, may be configured to detect deformation of the one or more battery cells 50 (e.g., via an alteration of an exterior pattern on the housing of the battery cells 50, a change in the reflected signal frequency received by the detector 510, detection of a sound of seeping gas from the battery cells 50, etc.). In response to detecting the deformation of the battery cells 50, the detector 510 may communicate with a fire suppression system, so as to initiate general delivery (e.g., uniform, etc.) of a suppressant to the battery module 40B. In some implementations, the detected deformation is sufficient such that the detector 510 is configured to communicate with a controller (e.g., the controller 102), so as to provide an alert to a user or supervisor. In this regard, the detector 510 of the battery module 40B may be configured to detect and/or address a deformation of one or more battery cells 50 throughout the battery module 40B, so as to prevent, eliminate, and/or mitigate the identified failure or thermal runaway event.

In other circumstances, one or more battery cells 50 (e.g., of the battery module 40C) may begin to operate at an elevated current level, resulting in a cascade elevation in temperature, pressure, and/or smoke. A detector coupled to, and/or adjacent with, an exterior of the battery module 40C may be configured to detect deformation of the battery module 40C (and/or the battery cells 50 contained therein), for example by detecting a change in energy (e.g., an increase in temperature) moving through one or more surfaces of the battery module 40C. In response to detecting the deformation of the battery module 40C, the detector 510 may communicate with a fire suppression system to initiate general delivery of a suppressant to the battery module 40C and/or the subpack 30. In some implementations, the cascade is sufficient such that the detector 510 is configured to communicate with a controller (e.g., the controller 102) to provide an alert to a user or supervisor, and/or communicate with one or more components of a vehicle (e.g., the vehicle 130) to initiate an automated action (e.g., shutdown, etc.) to mitigate the runaway. In this regard, the detector 510 may be configured to detect a deformation of the battery module 40C, and communicate with one or more systems or devices so as to mitigate the identified failure or thermal runaway event.

### Configuration of the Example Implementations

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “example” and variations thereof, as used herein to describe various implementations, are intended to indicate that such implementations are possible examples, representations, or illustrations of possible implementations (and such terms are not intended to connote that such implementations are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to some example implementations, and that such variations are intended to be encompassed by the present disclosure.

The hardware and data processing components used to implement the various processes, operations, illustrative logics, logical blocks, modules and circuits described in connection with the implementations disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example implementation, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various example implementations is illustrative only. Additionally, any element disclosed in one implementation may be incorporated or utilized with any other implementation disclosed herein. For example, the arrangement of multiple battery packs 20 of the example implementation shown in at least FIG. 4 may be incorporated in the vehicle 130 of the example implementation shown in at least FIG. 3. Although only one example of an element from one implementation that can be incorporated or utilized in another implementation has been described above, it should be appreciated that other elements of the various implementations may be incorporated or utilized with any of the other implementations disclosed herein.

What is claimed is:

1. A battery pack, comprising:
a housing defining a volume;
a battery module arranged within the housing, wherein the battery module comprises a plurality of battery cells configured to provide an electrical output; and
a first detector positioned within the battery module proximate to the plurality of battery cells, wherein the first detector is configured to detect a deformation of one of the plurality of battery cells to identify a potential thermal runaway.

2. The battery pack of claim 1, wherein the first detector is configured to detect a deformation of one of the plurality of battery cells based on a comparison of a measured characteristic of the battery cell to a predefined characteristic threshold.

3. The battery pack of claim 1, wherein the deformation of the one of the plurality of battery cells is a detected change in a characteristic of the battery cell.

4. The battery pack of claim 1, wherein the first detector is coupled to one of the plurality of battery cells, and wherein the first detector includes a strain gauge configured to detect the deformation of a housing of the one of the plurality of battery cells.

5. The battery pack of claim 1, wherein an exterior surface of housings of the plurality of battery cells include a pattern.

6. The battery pack of claim 5, wherein the first detector is coupled to an interior wall of the battery module, and wherein the first detector includes an optical sensor configured to detect the deformation of the one of the plurality of battery cells via an alteration of the pattern on the exterior surface of the housing.

7. The battery pack of claim 1, wherein the first detector is coupled to an interior wall of the battery module, and wherein the first detector includes an acoustic sensor configured to:
transmit an electromagnetic signal within the battery module; and
receive, via reflection off a housing of the one of the plurality of battery cells, a reflected electromagnetic signal at a first frequency.

8. The battery pack of claim 7, wherein the acoustic sensor is configured to:
transmit the electromagnetic signal within the battery module; and
receive, via reflection off the housing of the one of the plurality of battery cells, the reflected electromagnetic signal at a second frequency in response to the deformation of the one of the plurality of battery cells.

9. The battery pack of claim 1, wherein the first detector includes an acoustic sensor configured to detect an audible sound or noise indicative of the potential thermal runaway.

10. The battery pack of claim 1, further comprising a second detector positioned within the battery pack, wherein the second detector is configured to detect a deformation of the battery module to identify a failure event.

11. The battery pack of claim 10, wherein the second detector is coupled to the battery module, and wherein the second detector includes a heat flux sensor configured to detect an increase in energy transfer through a surface of the battery module indicative of the potential failure event.

12. A vehicle comprising:
a chassis;
a plurality of tractive elements coupled with the chassis;
a prime mover coupled with the plurality of tractive elements, the prime mover configured to drive the plurality of tractive elements to propel the vehicle; and
a battery pack coupled with the prime mover, the battery pack comprising:
a housing defining a volume;
a battery module arranged within the housing, wherein the battery module comprises a plurality of battery cells configured to provide an electrical output; and
a first detector positioned within the battery module proximate to the plurality of battery cells, wherein the first detector is configured to detect a deformation of one of the plurality of battery cells to identify a potential thermal runaway.

13. The vehicle of claim 12, wherein the first detector is configured to detect a deformation of one of the plurality of battery cells based on a comparison of a measured characteristic of the battery cell to a predefined characteristic threshold.

14. The vehicle of claim 12, wherein the deformation of the one of the plurality of battery cells is a detected change in a characteristic of the battery cell.

15. The vehicle of claim 12, wherein the first detector is coupled to one of the plurality of battery cells, and wherein the first detector includes a strain gauge configured to detect the deformation of a housing of the one of the plurality of battery cells.

16. The vehicle of claim 12, wherein an exterior surface of housings of the plurality of battery cells include a pattern, wherein the first detector is coupled to an interior wall of the battery module, and wherein the first detector includes an optical sensor configured to detect the deformation of the one of the plurality of battery cells via an alteration of a pattern on the exterior surface of the housing.

17. A battery system comprising:
a housing defining a volume;
a battery module arranged within the housing, wherein the battery module comprises a plurality of battery cells configured to provide an electrical output;
a first detector positioned within the battery module proximate to the plurality of battery cells, wherein the first detector is configured to detect a deformation of one of the plurality of battery cells to identify a potential thermal runaway event; and
a suppression system having a suppressant, wherein the suppression system is configured to provide the suppressant to the battery module to mitigate the identified potential thermal runaway event.

18. The battery system of claim 17, wherein the first detector is configured to detect a deformation of one of the plurality of battery cells based on a comparison of a measured characteristic of the battery cell to a predefined characteristic threshold.

19. The battery system of claim 17, wherein the deformation of the one of the plurality of battery cells is a detected change in a characteristic of the battery cell.

20. The battery system of claim 17, wherein the first detector is coupled to one of the plurality of battery cells, and wherein the first detector includes a strain gauge configured to detect the deformation of a housing of the one of the plurality of battery cells.
